(19) United States
(12) Patent Application Publication
(10) Pub. No.: US 2007/0190347 A1
(43) Pub. Date: Aug. 16, 2007

(54) Gold-and cerium-oxide-based composition, method for the preparation and the use thereof in the form of a catalyst, in particular for carbon monoxide oxidation

(76) Inventors: Franck Fajardie, Rueil-Malmaison (FR); Stephan Verdier, Rueil-Malmaison (FR); Kazuhiko Yokota, Paris (FR)

Correspondence Address: Jean Louis Seugnet;Rhodia Inc, Legal Department, 8 Cedar Brook Drive CN 7500, Cranbury, NJ, 08512-7500, US

(21) Appl. No.: 10/588,642

(22) PCT Filed: Feb. 17, 2005
(86) PCT No.: PCT/FR05/00378

§ 371 Date: Aug. 4, 2006

(30) Foreign Application Priority Data
Feb. 18, 2004 (FR) 04 01615

(51) Int. Cl. B32B 15/04; B32B 9/00; A24D 3/06

(52) U.S. Cl. 428/469; 428/472; 131/341

(57) ABSTRACT

The invention relates to a gold-based composition on a cerium oxide-based support having a halogen content with respect to a molar halogen/gold ratio equal to or less than 0.04, wherein the gold is embodied in the form of particles whose size is equal to or less than 10 nm. Said composition is made by a method consisting in bringing a cerium oxide-based compound into contact with a gold halide-based compound, thereby forming the suspension thereof, the thus obtained medium pH being fixed to a value of at least 8, subsequently, in separating a solid from a reaction medium and in washing said solid with a basic solution. The inventive composition can be used in the form of a catalyst in carbon monoxide oxidation methods, for treating tobacco smoke and air.

The present invention relates to a composition based on gold and cerium oxide, its method of preparation and its use as catalyst, particularly for oxidizing carbon monoxide.

Gold-based catalysts already exist, used in particular in CO oxidation methods. Moreover, a number of these oxidation methods take place at relatively low temperatures, for example lower than 250° C., particularly in water gas shift reactions. Attempts have even been made to oxidize CO at ambient temperature, for example in air treatment processes, and/or under difficult conditions such as very high hourly space velocities (HSV), as is the case for example of the treatment of tobacco smoke.

The catalysts available today and usable from an economic standpoint do not offer sufficient performance to meet this need.

It is the object of the invention to provide effective catalysts at low temperatures and/or high HSV. For this purpose, the composition of the invention is based on gold, on a support based on cerium oxide, and is characterized in that its halogen content expressed by the halogen/gold molar ratio is equal to or lower than 0.04 and in that the gold is present in the form of particles equal to or lower than 10 nm in size.

The invention also relates to the method for preparing this composition which, in a first embodiment, is characterized in that it comprises the following steps:
a compound based on cerium oxide is contacted with a gold-halide-based compound, forming a suspension of these compounds, the pH of the medium thus formed being fixed at a value of at least 8;
the solid is separated from the reaction medium;
the solid is washed with a basic solution.

The invention also relates to a method according to a second embodiment which is characterized in that it comprises the following steps:
gold is deposited on a compound based on cerium oxide by impregnation or by ion exchange;
the solid issuing from the preceding step is washed with a basic solution having a pH of at least 10.

The compositions of the invention are effective at low temperatures, high HSV and also with low gold contents.

Other features, details and advantages of the invention will appear even more completely from a reading of the description that follows, and the various concrete but nonlimiting examples provided to illustrate it.

The periodic table of elements referred to in this description is the one published in the Supplement au Bulletin de la Société Chimique de France n°1 (January 1966).

Rare earth means the elements of the group consisting of yttrium and the elements of the periodic table with an atomic number of between 57 and 71 inclusive.

Specific surface area means the BET specific surface area determined by nitrogen adsorption according to standard ASTM D 3663-78 based on the BRUNAUER-EMMETT-TELLER method described in The Journal of the American Chemical Society, 60, 309 (1938).

As stated above, the composition of the invention comprises gold and cerium oxide. The cerium oxide forms a support.

The term “support” must be understood in a broad sense to designate, in the composition of the invention, the majority component or components in the composition, the supported element essentially being present at the surface of these components. For simplification, we shall speak in the rest of the description of a support and a supported phase, but it should be understood that we would not extend beyond the scope of the present invention in the case in which an element described as belonging to the supported phase were present in the support, for example by having been introduced therein during the actual preparation of the support.

It should be noted that the composition of the invention may contain gold with, in addition, at least one other metal element selected from silver, platinum, palladium and copper. In this case, the other metal element(s) may be present for example in a quantity equal to or less than 400%, more particularly equal to or less than 120% and especially between 5% and 50% compared to the gold, this quantity being expressed as mol % of metal element(s)/gold. The compositions of this type, when used at high HSV, can reach their maximum efficiency even more rapidly.

The gold contents, or contents of gold and abovementioned metal element, of the composition are not critical, and correspond to the contents generally used in catalysts to obtain catalytic activity. For example, this content is equal to or less than 5%, especially equal to or less than 1%. It may be more particularly equal to or less than 0.5% and even equal to or less than 0.25%. Contents higher than 5% generally have no economic interest. These contents are expressed as a mass percentage of gold, optionally with the metal element, with respect to the cerium oxide (or oxides) making up the support.

As regards the support, use is made of a compound having a sufficiently high specific surface area to permit a dispersion of the gold at its surface such that the gold has a sufficient catalytic activity.

Use may in particular be made of cerium oxides possessing a stabilized specific surface area. This is understood to mean cerium oxides which have a high specific surface area, even after having been exposed to high temperatures.

Mention may thus be made of the cerium oxides disclosed in patent applications EP-A-153 227, EP-A-153 228, EP-A-239 478 and EP-A-275 733. These oxides can have surface areas of at least 85 m²/g, in particular of at least 100 m²/g, after calcination at a temperature of between 350 and 450° C. over a period of 6 hours for example.

Use may also be made of the cerium oxide disclosed in EP-A-300 852, which exhibits a specific surface area of at least 15 m²/g after calcination at a temperature of between 800° C. and 900° C. for 2 hours at least, or else of the cerium oxide disclosed in EP-A-388 567, which exhibits a surface area of at least 190 m²/g after calcination at a temperature of between 350° C. and 450° C. for 2 hours at least with in addition also a specific surface area of at least 15 m²/g after calcination at a temperature of between 800° C. and 900° C. for the same time.

Use may also be made, as advantageous support which also has a high specific surface area, of compositions based on a cerium oxide and on a zirconium oxide. The respective proportions of cerium and of zirconium in these compositions can vary within a wide range, for example within a ratio by weight of cerium oxide to zirconium oxide of between 1/99 and 99/1. However, use may more particularly be made of the compositions in which there exists a cerium/zirconium atomic proportion of at least 1.

Mention may thus be made of the cerium oxide disclosed in EP-A-207 857, which has a specific surface area higher than 10 m²/g up to a temperature of 900° C. This oxide can in particular have a zirconium oxide content of between 1 and 20% with respect to the weight of the ceric oxide. Mention may also be made of the composition based on cerium oxide and on zirconium oxide which forms the subject matter of EP-A-605 274 and in which the zirconium is in solid solution in the cerium oxide. This composition can have a specific surface area of at least 30 m²/g after calcination at 800° C. for 6 hours.

Use may also be made, as support, of compositions with a high specific surface area of the type based on a cerium oxide and on a zirconium oxide and on at least one oxide chosen from scandium oxide and oxides of rare earth elements other than cerium.

Such compositions are disclosed in particular in EP-A-906 244. In the latter document, the compositions have a cerium/zirconium atomic proportion of at least 1 and a specific surface area of at least 35 m²/g after calcination at 900° C. for 6 hours. This surface area can more particularly be at least 40 m²/g. It can more particularly still be at least 45 m²/g.

These compositions can correspond to the formula CeₓZr_{y}M_{z}O₂ in which M represents at least one element chosen from the group consisting of scandium and the rare earth elements with the exception of cerium and z preferably has a value of at most 0.3 and which can more particularly be between 0.02 and 0.2, the ratio x/y can be between 1 and 19, more particularly between 1 and 9 and more particularly still between 1.5 and 4, the values of the limits other than 0 being included and x, y and z being connected by the relationship x+y+z=1.

Supports which can be used are also those based on a cerium oxide and on a praseodymium oxide. The amount of praseodymium can vary within wide limits. Generally, this proportion can range up to a ratio by weight, expressed as praseodymium oxide with respect to the cerium oxide, of 50%. It is generally at least 0.5%. This proportion can thus be between 1 and 40%, in particular between 1 and 20%, more particularly between 1 and 10%. According to an alternative form, the composition can additionally comprise zirconium. Finally, the compositions of this type have, after calcination at 400° C. for 6 hours, a specific surface area of at least 10 m²/g, preferably of at least 60 m²/g and more particularly of at least 80 m²/g. Compositions of this type are disclosed in EP-A-802 824.

It is also possible to use, for the present invention, a compound based on a cerium oxide and on at least one oxide of another metal element M chosen from bismuth and tin, this oxide preferably being in solid solution with the cerium oxide. Such compounds are disclosed in EP-A-588 691. The atomic ratio of the element M to the cerium can be between 1% and 50%.

Finally, use may be made, as support, of a compound based on a cerium oxide and on titanium oxide. The atomic ratio of the element Ti to the cerium is lower than 50% and between 1% and 50%, for example.

However, it should be clearly noted that the compositions based on cerium oxide which have just been described above have been given only by way of examples. It is entirely possible to use compositions having lower surface areas, for example lower than 80 m²/g after calcination at 350° C., insofar as, as indicated above, it is sufficient for these compositions to have surface areas sufficient to permit the gold to act as catalyst.

Finally, it should be noted here that, in the context of the present invention, the cerium used in the composition of the support is present in a form which consists essentially or exclusively of cerium oxide. “Consists essentially” means here that amorphous species of the cerium hydroxide or oxyhydroxide type, for example, are only present in traces.

By defining as amorphous any product of which the XR diffractogram does not display diffraction lines centered on the oxide phase or of which the XR diffractogram displays halos centered on the oxide phase but of which the width at mid-height would serve to calculate crystallite sizes lower than 2 nm by the Debye-Scherrer method, it must be understood, in the context of the present invention, by the expression: “amorphous species are only present in traces”, that the comparison of an XR diagram of a pure cerium oxide with that of a cerium oxide containing these species does not reveal any detectable differences and particularly does not reveal halos.

These comments apply to the case where the support comprises oxides of several elements as described above (in particular zirconium, rare earth elements, titanium). In this case, these elements are also essentially or exclusively in the oxide form within the meaning given above.

The composition of the invention has two new specific features.

The first is its halogen content. The halogen may be more particularly bromine or chlorine. This content, which is expressed by the halogen/gold molar ratio, is equal to or less than 0.04. More particularly, it is equal to or less than 0.025 and even more particularly equal to or less than 0.01.

The halogen can be determined by using the following method. The quantity of catalyst necessary for analysis is vaporized in the flame of an oxyhydrogen gas blowpipe (H₂/O₂ mixture at about 2000° C.). The resulting vapor is trapped in an aqueous solution containing hydrogen peroxide. If a solid residue is obtained after the treatment with the oxyhydrogen gas blowpipe, it is placed in suspension in the solution in which the combustion gases (water+H₂O₂) have been collected, and is then filtered. The filtrate collected is then analyzed by ionic chromatography and the halogen content calculated by incorporating the appropriate dilution factor. The halogen content of the catalyst is finally calculated by taking account of the mass of catalyst used for the analysis.

The other feature is the size of the gold particles present in the composition. This size is equal to or lower than 10 nm, preferably equal to or lower than 3 nm.

Here, and for the rest of the present description, this size is determined by the analysis of the X-ray spectra of the composition, using the width (w) at mid-height of the gold diffraction peak. The particle size is proportional to the inverse (1/w) of the value of this width w. It may be noted that XR analysis is unsuitable for detecting a phase corresponding to gold for particles lower than 3 nm in size, or for detecting gold for gold contents lower than 0.25%. In these two cases, TEM analysis can be used.

The method for preparing the composition of the invention will now be described.

This method can be carried out according to a first embodiment.

In this first embodiment, the first step of the method consists in contacting a cerium-oxide-based compound with a gold-halide-based compound and, if applicable, with a compound based on silver, platinum, palladium or copper. This contacting is carried out by forming a suspension that is generally an aqueous suspension.

This initial suspension can be obtained from a preliminary dispersion of a cerium-oxide-based support of the type described above, prepared by dispersing this support in a liquid phase, and by mixing with a solution or a dispersion of the gold compound. As a compound of this type, use can be made of the chlorine or bromine compounds of gold, for example, chlorauric acid HAuCl₄ or its salts such as NaAuCl₄ which are the most common compounds.

In the case of the preparation of a composition also comprising silver, platinum, palladium or copper, inorganic acid salts such as nitrates, sulfates or chlorides can be selected as compounds of these elements.

Use can also be made of organic acid salts and particularly salts of saturated aliphatic carboxylic acids or salts of hydroxycarboxylic acids. As examples, mention can be made of formates, acetates, propionates, oxalates or citrates. Finally, for platinum, mention can in particular be made of tetrammine platinum(II) hydroxide.

For the rest of the description of the method, only the gold-halide-based compound will be mentioned, but it should be understood that the description applies similarly to the case in which a compound of silver, platinum, palladium or copper is used as described above.

The initial suspension can be obtained, for example, by introducing the solution or dispersion of the gold compound into the dispersion of the support.

According to a specific feature of the method, the pH of the suspension thus formed is adjusted to a value of at least 8, more particularly at least 8.5 and even more particularly at least 9.

Preferably, the pH is maintained at the value of at least 8 during the formation of the suspension, during the contacting of the cerium-oxide-based compound and the gold-halide-based compound, by the concomitant introduction of a basic compound. For example, when introducing the gold compound solution or dispersion into the dispersion of the support, a basic compound is added simultaneously. The flow rate of basic compound can be adjusted in order to maintain the pH of the medium at a constant value, that is a value that is plus or minus 0.3 pH unit about the fixed value.

As a basic compound, use can be made particularly of products of the hydroxide or carbonate type. Mention can be made of alkali metal or alkaline-earth metal hydroxides and ammonia. Use can also be made of secondary, tertiary or quaternary amines. Mention can also be made of urea. The basic compound is generally used in solution form.

According to a variant of the method, use can be made of a dispersion of the support and a solution or dispersion of the gold compound, which have both been previously adjusted to a pH of at least 8, making it unnecessary to add a basic compound when they are contacted.

The contacting of the cerium-oxide-based compound and the gold-halide-based compound generally takes place at ambient temperature but it can also be carried out at higher temperature, for example at a temperature of at least 60° C.

The suspension formed in the first step of the method is generally maintained with stirring for a few minutes.

In a second step, the solid is separated from the reaction medium by any known means.

The solid thereby obtained is then washed with a basic solution. Preferably, this basic solution has a pH of at least 8, more particularly at least 9. The basic solution may be based on the same basic compounds as those mentioned above.

This washing can be carried out by any convenient method, for example by using the piston washing technique or by redispersion. In the latter case, the solid is redispersed in the basic solution and then, generally after keeping stirred, the solid is separated from the liquid medium.

The washing with the basic solution can be repeated several times if necessary. It may optionally be followed by washing with water.

On completion of the washing, the solid obtained is generally dried. The drying can be carried out by any convenient method, for example with air or by freeze drying.

It is not generally necessary to carry out calcination. However, such calcination is not ruled out, preferably at low temperature, that is to say at equal to or not higher than 250° C., for a time of at most 4 hours, for example, and under air.

According to an alternative form of the invention, the product, in particular after the drying, can be subjected to a reducing treatment. This treatment is carried out so that all of the gold has a degree of oxidation lower than its degree of oxidation before the treatment, the degree of oxidation before treatment generally being 3. The degree of oxidation of the gold can be determined by techniques known to a person skilled in the art, for example by the programmed temperature reduction (PTR) method or by X-ray photoelectron spectroscopy (XPS).

Various types of reducing treatment can be considered.

A chemical reduction can first be carried out by contacting the product with a reducing agent such as ferrous, citrate or stannous ions, oxalic acid, citric acid, hydrogen peroxide, hydrides like NaBH₄, hydrazine (NH₂-NH₂), formaldehyde in aqueous solution (H₂CO), phosphorus reducing agents including tetrakis(hydroxy-methyl)phosphonium chloride or NaH₂PO₂. This treatment can be carried out by placing the suspension of product in an aqueous medium containing the reducing agent or also on the product in the reaction medium after deposition of the gold. In the case of the use of this type of reduction, it can be advantageous to subsequently carry out calcination under the conditions described above.

Reduction can also be carried out under ultraviolet radiation; the treatment can be carried in this case on a solution or suspension of the product or on a powder.

In the case of these two types of reducing treatment, these treatments can be carried out before or after the washing step described above.

Finally, the reducing treatment can be carried out by a gas method using a reducing gas which can be selected from hydrogen, carbon monoxide or hydrocarbons, this gas being usable in any volumetric concentration. Use can be made most particularly of hydrogen diluted in argon. In the case of a reducing treatment of the latter type, it is carried out after the abovementioned washing step.

In this case, the treatment is carried out at a temperature equal to or lower than 200° C., preferably equal to or lower than 180° C. The duration of this treatment may be between 0.5 and 6 hours in particular.

On completion of the reducing treatment, calcination as described above can optionally be carried out.

The method of the invention can also be implemented according to a second embodiment which will now be described.

The first step consists in depositing the gold and, if applicable, silver, platinum, palladium or copper on the compound based on cerium oxide by impregnation or by ion exchange.

The impregnation method is well known. Dry impregnation is preferably used. Dry impregnation consists in adding to the product to be impregnated, here the cerium-oxide-based support, a volume of a solution of the gold compound which is equal to the pore volume of the solid to be impregnated.

The gold compound here is of the same type as the one described above for the first embodiment.

Deposition by ion exchange is also a known method. The same type of gold compound can be used here as previously employed.

In the second step of the method, the product issuing from the preceding step is then washed with a basic solution of which the pH is at least 10, preferably at least 11. This washing can be carried out in the same way and with the same basic compounds as was described for the method according to the first embodiment.

Moreover, a reducing and drying treatment can also be carried out in the second embodiment, in the same way as the one described above.

Finally, it should be noted that it is also possible, in the case of the preparation of a compound based, in addition to gold, on another metal element, to first deposit this metal element on the support, for example by impregnation, and then, subsequently, to deposit the gold by following the methods described above.

The compositions of the invention as obtained by the method described above are in the form of powders, but they may optionally be shaped into the form of granules, beads, cylinders, extrudates or honeycombs of variable dimensions. They may be used in catalyst systems comprising a wash coat based on these compositions, on a substrate of the metal or ceramic monolith type, for example. The wash coat may, for example, comprise alumina. It may be observed that the gold can also be deposited on a support previously shaped into a form of the type given above.

The compositions of the invention, as described above or obtained by the method described above, can be used more particularly, as catalysts, in methods for oxidizing carbon monoxide.

They are most particularly effective for methods of this type which are carried out at low temperatures, which means temperatures equal to or lower than 250° C. They are even effective at ambient temperature. Ambient temperature means, here and for the rest of the description unless otherwise indicated, a temperature equal to or lower than 50C., more particularly in a range from 10° C. to 40° C. Finally, they can also be effective under high HSV conditions which, for example, may be as high as 600 000 cm³/g_{cata}/h.

Thus, as an example of use in methods for oxidizing carbon monoxide, they can be employed in the treatment of a tobacco smoke, in the water gas shift reaction (CO+H₂O→CO₂ +H₂) at a temperature lower than 100° C. in particular, or in the treatment of reforming gases at a temperature lower than 150° C., treatment of the PROX type (preferential oxidation of CO in the presence of hydrogen).

In the particular case of the treatment of tobacco smoke, the catalyst composition may be in the form of a powder. It may also undergo appropriate shaping; for example, it can be shaped into granules or flakes. In the case of a powder, the particle size distribution of the composition may be between 1 μm and 200 μm. In the case of granules, this size may be between 700 μm and 1500 μm, the size may be between 200 μm and 700 μm for beads, and between 100 μm and 1500 μm for flakes.

The catalyst composition can be incorporated by mixing or bonding with the fiber used to make the cigarette filter (for example cellulose acetate) during the production of the filter, particularly in the case of “dual filter” or “triple filter” filters. The catalyst composition can also be deposited on the inside of the paper enveloping the cable making up the filter (tipping paper) in the case of a filter of “patch filter” type. The catalyst composition can also be introduced into the cavity of a filter of “cavity filter” type.

If the catalyst composition of the invention is used in a cigarette filter, the reducing treatment can be applied to the composition after it is incorporated in the filter. The reducing treatment is then carried out by the methods described above.

The quantity of catalyst composition used is not critical. It is limited particularly by the dimensions of the filter and the pressure drop due to the presence of the composition in the filter. It is generally not more than 350 mg per cigarette, and is preferably between 20 mg and 100 mg per cigarette.

Hence the invention relates to a cigarette filter, which contains a composition as described above or obtained by the method described above.

It should be noted here that the term “cigarette” must be considered in the broad sense to cover any article intended to be smoked and based on tobacco wrapped in a tube based, for example, on paper or tobacco. Hence this term applies here also to cigars and cigarillos.

Finally, the compositions of the invention can also be used in air purification treatments in the case of an air containing at least one compound such as carbon monoxide, ethylene, aldehyde, amine, mercaptan, ozone and, in general, of the type of volatile organic compounds or atmospheric pollutants such as fatty acids, hydrocarbons, particularly aromatic hydrocarbons, and nitrogen oxides (for the oxidation of NO to NO₂) and of the type of malodorous compounds. As compounds of this type, mention can be made more particularly of ethanethiol, valeric acid and trimethylamine. This treatment is carried out by contacting the air to be treated with a composition as described previously or obtained by the method described above. The compositions of the invention are suitable for carrying out this treatment at ambient temperature.

Examples will now be provided.

In a first series of examples, results are given for the oxidation of CO. These results were obtained by using the CO catalytic oxidation test as described below.

The catalyst compound is tested in the form of 125 to 250 μm flakes which are obtained by pelletizing, crushing and screening the catalyst compound powder. The catalyst compound is placed in the reactor on a sintered glass which acts as a physical support for the powder.

In this test, a synthetic mixture containing 1 to 10 vol % of CO, 10 vol % of CO₂, 10 vol % of O₂, 1.8 vol % of H₂O in N₂ is passed over the catalyst. The gas mixture flows continuously in a quartz reactor containing between 25 and 200 mg of catalyst compound with a flow rate of 30 L/h.

When the mass of catalyst compound is lower than 200 mg, silicon carbide SiC is added so that the sum of the masses of catalyst compound and SiC is equal to 200 mg. SiC is inert to the CO oxidation reaction and plays the role of diluent here, to ensure the homogeneity of the catalyst bed.

The CO conversion is first measured at ambient temperature (T=17-25° C. in the following examples) and it is only when this conversion is not total at this temperature that it is increased using an oven from ambient temperature to 300° C. with a gradient of 10° C./min. The gases leaving the reactor are analyzed by infrared spectroscopy at intervals of about 10 s to measure the conversion of CO to CO₂.

If the CO conversion is not total at ambient temperature, the results are expressed as the semi-conversion temperature (T50%), temperature at which 50% of the CO present in the gas stream is converted to CO₂.

In the examples below, the catalyst compounds were evaluated for the oxidation of CO to CO₂ under the following conditions.

Conditions A: 3 vol % CO-HSV=300 000 cm³/g_{cata}/h

Gas mixture: 3 vol % CO, 10 vol % CO₂, 10 vol % O₂,1.8 vol % H₂O in N₂
Total flow rate: 30 L/h
Catalyst mass: 100 mg
HSV: 300 000 cm³/g_{cata}/h
   Conditions B: 3 vol % CO-HSV=600 000 cm³/g_{cata}/h
Gas mixture: 3 vol % CO, 10 vol % CO₂, 10 vol % O₂, 1.8 vol % H₂O in N₂
Total flow rate: 30 L/h
Catalyst mass: 50 mg
HSV: 600 000 cm³/g_{cata}/h
   Conditions C: 10 vol % CO-HSV=600 000 cm³ /g_{cata}/h
Gas mixture: 10 vol % CO, 10 vol % CO₂, 10 vol % O₂, 1.8 vol % H₂O in N₂
Total flow rate: 30 L/h
Catalyst mass: 50 mg
HSV: 600 000 cm³/g_{cata}/h

### EXAMPLE 1

40 g of a Rhodia cerium oxide powder with a surface area of 170 m²/g were dispersed with stirring in 250 ml of water. The pH of the suspension was then adjusted to 9 by adding a solution of 1M Na₂CO₃.

Simultaneously, 0.8 g of HAuCl₄.3H₂O (Sigma-Aldrich) was dissolved in 250 ml of water.

The gold solution was then added in one hour to the cerium oxide suspension. The pH of the suspension was maintained between pH 8.7 and 9.3 during the addition of the gold solution by adding a solution of 1M Na₂CO₃. The resulting suspension was maintained with stirring for 20 minutes and then filtered under vacuum.

The cake obtained was redispersed in a Na₂CO₃ solution at pH 9, the volume of which was equivalent to that of the mother liquor removed during the first filtration step. The suspension was maintained with stirring for 20 minutes. This basic washing procedure was repeated twice more. The cake obtained was finally redispersed in a volume of water equivalent to the volume of mother liquor removed during the first filtration and then filtered under vacuum.

The washed cake was dried under air at 100° C. for 2 hours and then treated for 2 h at 170° C. by a gas mixture composed of 10 vol % of dihydrogen diluted in argon.

The analyses performed on the catalyst gave the results shown in Table 1 below.

### EXAMPLE 2

The catalyst was prepared according to the same protocol as the one described in Example 1, except that the washed cake was freeze-dried before treatment under hydrogen.

The analyses performed on the catalyst gave the results shown in Table 1 below.

### EXAMPLE 3

The catalyst was prepared according to the same protocol as the one described in Example 1 except that the product was freeze-dried and was not treated under hydrogen after the drying step.

The analyses performed on the catalyst gave the results shown in Table 1 below.

### COMPARATIVE EXAMPLE 4

The catalyst was prepared according to the same protocol as the one described in Example 1, except that the product was not washed (neither washing with the Na₂CO₃ solution nor washing with water) before drying under air and treatment under hydrogen.

The analyses performed on the catalyst gave the results shown in Table 1 below.

### COMPARATIVE EXAMPLE 5

The catalyst was prepared according to the same protocol as the one described in Example 1, except that the product was subjected only to washing with water (redispersion in a volume of water equivalent to the volume of mother liquor removed during the filtration step) and not to basic washing before drying under air and treatment under hydrogen.

The analyses performed on the catalyst gave the results shown in Table 1 below.

### EXAMPLE 6

The catalyst was prepared according to the same protocol as the one described in Example 1, except that 0.4 g of HAuCl₄.3H₂O was added instead of 0.8 g and that the washed cake was freeze-dried before treatment under hydrogen.

The analyses performed on the catalyst gave the results shown in Table 1 below.

### EXAMPLE 7

The catalyst was prepared according to the same protocol as the one described in Example 1, except that 0.2 g of HAuCl₄.3H₂O was added instead of 0.8 g and that the washed cake was freeze-dried before treatment under hydrogen.

The analyses performed on the catalyst gave the results shown in Table 1 below.

### COMPARATIVE EXAMPLE 8

This example describes a product for which the gold is deposited on the support by a method having different pH conditions from the ones of the invention and without basic washing.

3 g of the starting cerium oxide powder of Example 1 were dispersed in 300 ml of water at 60° C. with stirring.

5 ml of a 0.09M HAuCl₄.3H₂O solution was subsequently added to the cerium oxide suspension while regulating the pH at 6.5-7.0 by simultaneous addition of a 0.15M aqueous NaOH solution.

The suspension was maintained at 60° C. with stirring for 30 min and then filtered, and the cake was washed several times with water at 40° C.

The product obtained was dried under vacuum at ambient temperature for 15 h and then treated at 200° C. under H₂ for ¾ of an hour.

The catalyst obtained was gray-brown in color. The analyses performed on the catalyst gave the results shown in Table 1 below.

### COMPARATIVE EXAMPLE 9

This example describes a product for which the gold is deposited on the support by an impregnating process without basic washing.

The catalyst was obtained by impregnating an aqueous HAuCl₄.3H₂O solution on a cerium oxide powder of Example 1. The aqueous solution was evaporated and dried. The powder obtained was subsequently calcined under air at 500° C. for 2 hours and then treated under a mixture of hydrogen diluted to 5% in nitrogen at 500° C. for 1 hour.

The analyses performed on the catalyst gave the results shown in Table 1 below.

### EXAMPLE 10

40 g of cerium oxide (starting powder of Example 1) were impregnated with 14 ml of a 0.15M aqueous HAuCl₄.3H₂O solution. The paste was suspended in 500 ml of an aqueous solution adjusted beforehand to pH 11 with Na₂CO₃. The suspension was maintained with stirring for 2 hours. During this period, the pH of the suspension was maintained at pH 11 by addition of a 2M aqueous Na₂CO₃ solution. The suspension was subsequently filtered under vacuum.

The cake obtained was resuspended in a volume of pure water equivalent to the volume of mother liquor removed during the filtration step.

The suspension was filtered and the cake obtained was freeze-dried.

The powder obtained was treated at 170° C. for 1 hour under a mixture of hydrogen diluted to 10% in argon.

The analyses performed on the catalyst gave the results shown in Table 1 below.

### EXAMPLE 11

An example is given here of the preparation of a catalyst in the form of granules.

21 g of granules of cerium oxide (CeO₂)/alumina (A1₂O₃) (90/10 by weight of oxide) with a specific surface of 140 m²/g were placed in a column. This column was connected via a circulation system to a reactor (1) containing 125 g of water.

Simultaneously, 0.4 g of HAuCl₄.3H₂O was dissolved in a reactor (2) containing 125 g of water.

The solution contained in the reactor (1) was circulated through the column containing the CeO₂/Al₂O₃ granules with a flow rate of 10 mL/min. Once circulation was established between the reactor (1) and the column, the pH in the reactor (1) was adjusted to 11 using a solution of 1M Na₂CO₃.

The gold solution was introduced with stirring into the reactor (1) in 30 minutes. The pH was maintained at 11 in the reactor (1) by a solution of 1M Na₂CO₃. The solution was maintained with stirring for 1 h after adding the gold solution.

Circulation was stopped between the reactor (1) and the column.

The mother liquor was drawn off, then replaced by 250 g of water (pH adjusted to 11 with 1M Na₂CO₃ at ambient temperature). Circulation was resumed between the reactor (1) and the column for 10 minutes. This operation was repeated twice before two further washing operations with 450 g of water.

The granules were separated from the wash solution and freeze-dried. They were then reduced for 2 h at 170° C. by a gas mixture composed of 3 vol % of dihydrogen diluted in argon.

The analyses performed on the catalyst gave the results shown in Table 1 below.

The example below illustrates a chemical reducing treatment.

### EXAMPLE 12

40 g of a Rhodia cerium oxide powder with a surface area of 170 m²/g were dispersed with stirring in 250 ml of water. The pH of the suspension was then adjusted to 11 by adding a solution of 1M NaOH.

Simultaneously, 0.8 g of HAuCl₄.3H₂O (Sigma-Aldrich) was dissolved in 250 ml of water.

The gold solution was then added in one hour to the cerium oxide suspension. The pH of the suspension was maintained between pH 10.7 and 11.3 during the addition of the gold solution by adding a solution of 1M NaOH. 27.3 g of sodium citrate (Sigma-Aldrich) were then added. The resulting suspension was maintained with stirring for 20 minutes and then filtered under vacuum.

The cake obtained was redispersed in a NaOH solution at pH 11, the volume of which was equivalent to that of the mother liquors removed during the first filtration step. The suspension was maintained with stirring for 20 minutes. This basic washing procedure was repeated twice more. The cake obtained was finally redispersed in a volume of water equivalent to the volume of mother liquors removed in the first filtration and then filtered under vacuum.

The washed cake was dried under vacuum and then calcined 5 under air at 200° C. for 2 h.

The analyses performed on the catalyst gave the results shown in Table 1 below.

TABLE 1

| | Au particle size | Au content | Cl/Au |
|---|---|---|---|
| Example | (nm) | (%) | (molar) |
| 1 | <3 | 0.98 | 0.008 |
| 2 | <3 | 0.98 | 0.008 |
| 3 | <3 | 0.98 | 0.008 |
| 4, comparative | 6 | 0.98 | 0.23 |
| 5, comparative | 4 | 0.98 | 0.057 |
| 6 | <3 | 0.49 | 0.023 |
| 7 | <3 | 0.24 | 0.023 |
| 8, comparative | 5.5 | 2.7 | 0.1 |
| 9, comparative | 28 | 1.00 | 3.9 |
| 10 | <3 | 1.00 | 0.039 |
| 11 | <3 | 0.52 | 0.032 |
| 12 | <3 | 1.00 | 0.005 |

Table 2 below gives the results obtained with the catalysts of the various examples for the conversion of CO.

TABLE 2

| | Conversion of CO | | |
|---|---|---|---|
| Example | Conditions A | Conditions B | Conditions C |
| 1 | 100% at Ta | 100% at Ta | — |
| 2 | 100% at Ta | — | 100% at Ta |
| 3 | 50% at 43° C. | — | 50% at 45° C. |
| 4, comparative | 50% at 75° C. | — | — |
| 5, comparative | 50% at 72° C. | — | — |
| 6 | 100% at Ta | — | — |
| 7 | 100% at Ta | — | — |
| 8, comparative | 50% at 57° C. | — | — |
| 9, comparative | 50% at 284° C. | — | — |
| 10 | 100% at Ta | 50% at 48° C. | — |
| 11 | 100% at Ta | 100% at Ta | |
| 12 | — | 100% at Ta | |

Ta: ambient temperature = 17-25° C.

The example below concerns the oxidation of acetaldehyde CH₃CHO. These results were obtained by using the catalytic test for the oxidation of CH₃CHO described below.

In this test, a glass chamber with a volume of 1.11 L is equipped with two orifices, one for introducing the acetaldehyde and catalyst and the other for sampling the gas phase.

Initially, a volume of liquid acetaldehyde (B.p.=21° C.) of between 0.7 and 2.8 pL is introduced using a syringe cooled to 10° C. At ambient temperature (T=20 to 30° C.), all the acetaldehyde is vaporized in the chamber to create an atmosphere consisting of 250 to 1000 ppm of acetaldehyde in air.

Subsequently, 100 mg of catalytic compound in powder form are introduced into the chamber using a device avoiding any contact with the atmosphere outside the chamber. The time origin is determined by the introduction of the catalyst into the chamber. The gas phase is homogenized using a magnetic stirrer.

To monitor the acetaldehyde oxidation reaction, the gas phase of the chamber was sampled through a septum using the sampling device with which a Hewlett Packard Micro GC HP M200 chromatograph was equipped. This chromatograph made it possible to analyze H₂O, CO, CO₂ and the various compounds which have between 1 and 4 carbon atoms. The gas phase was analyzed before introduction of the catalyst and then after introduction at regular intervals from approximately 3 minutes up to complete conversion of the acetaldehyde.

The conversion of acetaldehyde was calculated as follows using the chromatogram areas:

Conv (CH₃CHO)=[areacH₃cHO(t)-areacH₃cHo(t=0) ] /areacH₃cHo (t=0)

### EXAMPLE 13

The catalyst of example 1 was used in the test which was described above.

Table 3 below gives the results obtained at ambient temperature for the conversion of 250 ppm of acetaldehyde.

TABLE 3

| Time (min) | CH₃CHO Conv. |
|---|---|
| 0 | 0 |
| 1 | 30 |
| 4 | 65 |
| 7 | 83 |
| 10 | 94 |
| 16 | 99 |
| 20 | 100 |

Similarly, the results obtained at ambient temperature for the conversion of 1000 ppm of acetaldehyde are given below.

TABLE 4

| Time (min) | CH₃CHO Conv. |
|---|---|
| 0 | 0 |
| 6 | 72 |
| 16 | 92 |
| 30 | 99 |
| 40 | 100 |

These data show that 250 and 1000 ppm of acetaldehyde were converted to over 90% after 10 and 16 minutes respectively and were converted completely in 20 and 40 min respectively.

Chromatographic analysis confirmed that the quantities of CO₂ and H₂O produced clearly corresponded to a total oxidation reaction leading to the removal of the acetaldehyde according to the equation:
CH₃CHO+5/20₂→2CO₂+2H₂O

The examples below concern the oxidation of ethanethiol (CH₃CH₂SH), valeric acid (CH₃ (CH₂)₃CO₂H) and trimethylamine ((CH₃)₃N). These results were obtained by using the catalytic oxidation test described below.

In this test, a closed polymer chamber with a volume of 5.3 L is equipped with several orifices for introducing the molecule to be oxidized, for introducing the catalyst and for sampling the gas phase.

Initially, a volume of liquid molecule is introduced using a syringe into the closed chamber. The injected volumes are 3.5, 5 and 6 μL respectively for acetaldehyde, methanol, ethanethiol, valeric acid and trimethylamine (in 50% aqueous solution). At ambient temperature (T=20 to 30° C.), all the injected liquid is vaporized in the chamber to create an atmosphere consisting of 200 vpm of molecule to be oxidized in air.

Subsequently, 200 mg of catalyst compound in powder form is introduced into the chamber using a device avoiding any contact with the atmosphere outside the chamber. The time origin is determined by the introduction of the catalyst into the chamber. The gas phase is homogenized using a recirculating pump with a delivery of 13.5 L/min.

To monitor the oxidation reaction, the gas phase of the chamber was sampled through a septum and analyzed by gas chromatography. H₂O, CO, CO₂ and CH₃CH₂SH were analyzed on a Hewlett Packard Micro GC HP M200 chromatograph using the sampling device with which this analyzer was equipped. Valeric acid (CH₃(CH₂)₃CO₂H) and trimethylamine ((CH₃)₃N) were analyzed on a Varian 3200 chromatograph using a gas syringe for sampling the gas phase of the closed chamber. The gas phase was analyzed before introduction of the catalyst and then after introduction at regular intervals of between 3 and 10 minutes.

The conversion of the molecule to be oxidized (M) was calculated as follows using the chromatogram areas:
Conv(M)=[area_{M}(t)−area_{M}(t=0)]/area_{M}(t=0)

For each molecule to be oxidized, a blank test without catalyst was performed under the same conditions, for which no change in the concentration of molecule to be oxidized was observed over time.

### EXAMPLE 14

The catalyst of example 1 was used in the test which was described above.

Table 5 below gives the results obtained at ambient temperature for the conversion of 200 vpm of ethanethiol.

TABLE 5

| Time (min) | CH₃CH₂SH Conv. |
|---|---|
| 0 | 0 |
| 6 | 35 |
| 20 | 56 |
| 42 | 65 |
| 65 | 71 |

These data show that 200 vpm of ethanethiol was converted to over 70% after 1 h of reaction.

The analysis of the gas phase with a Draeger sulfur dioxide SO₂ tube at t=50 min showed that over 100 vpm of SO₂ was present in the chamber. The changes in CO₂ and H₂O concentrations and the presence of SO₂ indicated that the disappearance of the ethanethiol could be attributed to its partial oxidation.

### EXAMPLE 15

The catalyst of example 1 was used in the test which was described above.

Table 6 below gives the results obtained at ambient temperature for the conversion of valeric acid.

TABLE 6

| | | Concentration |
|---|---|---|
| Injection 200 vpm | | CH₃(CH₂)₃CO₂H |
| CH₃(CH₂)₃CO₂H | Time (min) | (vpm) |
| 1^{st} injection | 0 | 200 |
| | 4 | 0 |
| | 12 | 0 |
| 2^{nd} injection | 16 | 0 |
| | 20 | 0 |
| | 28 | 0 |
| 3^{rd} injection | 32 | 9 |
| | 36 | 0 |

These data show that each of the injections of 200 vpm of valeric acid was converted in less than 3 minutes.

The analysis of the gas phase showed that overall 600 vpm of valeric acid were converted and that 100 vpm of CO₂ and 1500 vpm of H₂O were formed. The changes in CO₂, H₂O and valeric acid concentrations indicated that the disappearance of the valeric acid could be attributed to its partial oxidation.

### EXAMPLE 16

The catalyst of example 1 was used in the test which was described above.

Table 7 below gives the results obtained at ambient temperature for the conversion of 200 vpm of trimethylamine.

TABLE 7

| Time (min) | (CH₃)₃N Conv. |
|---|---|
| 0 | 0 |
| 5 | 66 |
| 10 | 71 |
| 20 | 80 |
| 30 | 83 |

These data show that 200 vpm of trimethylamine were converted to over 80% after 30 min of reaction.

The analysis of the gas phase showed that 50 vpm of CO₂ and 1000 vpm of H₂O were also formed. The changes in CO₂, H₂O and trimethylamine concentrations indicated that the disappearance of the trimethylamine could be attributed to its partial oxidation.

1-21. (canceled)

22. A gold-based composition on a support based on at least one cerium oxide, having a halogen content expressed by the halogen/gold molar ratio equal to or lower than 0.04 and wherein the gold is present in the form of particles equal to or lower than 10 nm in size.

23. The composition as claimed in claim 22, wherein the halogen content is equal to or lower than 0.025 and optionally equal to or lower than 0.01.

24. The composition as claimed in claim 22, wherein the gold is present in the form of particles equal to or lower than 3 nm in size.

25. The composition as claimed in claim 22, wherein the halogen is chlorine.

26. The composition as claimed in claim 22, wherein the gold content is equal to or lower than 5%, optionally equal to or lower than 1%.

27. The composition as claimed in claim 22, wherein the support is based on a cerium oxide and on a zirconium oxide, optionally in a cerium/zirconium atomic proportion of at least 1.

28. The composition as claimed in claim 22, wherein the support is based on a cerium oxide and on a zirconium oxide and on at least one oxide which is scandium oxide or oxides of rare earth elements other than cerium.

29. The composition as claimed in claim 22, wherein the support is based on a cerium oxide and on a praseodymium oxide; or on a cerium oxide and on at least one oxide of another element which is bismuth or tin; or based on a cerium oxide and on titanium oxide.

30. The composition as claimed in claim 22, further comprising at least one other metal element which is silver, platinum, palladium or copper.

31. The composition as claimed in claim 30, wherein the other abovementioned metal element is present in a quantity equal to or lower than 400%, optionally between 5% and 50%, compared with the gold.

32. A method for preparing a composition as defined in claim 22, comprising the following steps:
a) contacting a compound based on cerium oxide with a gold-halide-based compound and, optionally, a compound based on silver, platinum, palladium or copper,
b) forming a suspension of these compounds in a medium, the pH of the medium thereby formed being fixed at a value of at least 8;
c) separating the solid from the reaction medium of step b); and
d) washing the solid with a basic solution.

33. The method as claimed in claim 32, wherein in step c) the pH of the medium formed is maintained at the value of at least 8 during the formation of the suspension of the compound based on cerium oxide and of the gold-halide-based compound and, optionally, of the compound based on silver, platinum, palladium or copper, by the addition of a basic compound.

34. The method as claimed in claim 32, wherein the solid obtained in step b) is washed with a basic solution with a pH of at least 8, optionally of at least 9.

35. A method for preparing a composition as defined in claim 22, comprising the following steps:
a) depositing gold and, if applicable, silver, platinum, palladium or on a compound based on cerium oxide by impregnation or by ion exchange; and
b) washing the solid issuing from the preceding step a) with a basic solution with a pH of at least 10.

35. The method as claimed in claim 32, wherein the solid obtained, before or after step d), is further subjected to a reducing treatment.

36. The method as claimed in claim 35, wherein the reducing treatment takes place with a reducing gas at a temperature not higher than 200° C., optionally not higher than 180° C.

37. The method as claimed in claim 35, wherein the solid obtained after step d) and optionally after the reducing treatment is subjected to a calcination at a temperature not higher than 250° C.

38. A method for purifying air, this air containing carbon monoxide, ethylene, aldehyde, amine, mercaptan, ozone, a volatile organic compound, an atmospheric pollutant or a malodorous compound, comprising the step of contacting said air with a composition as defined in claim 22.

39. A cigarette filter, comprising a composition as defined in claim 22.
